(19) United States
(12) Patent Application Publication
(10) Pub. No.: US 2026/0017963 A1
(43) Pub. Date: Jan. 15, 2026

(54) DETECTION DEVICE

(71) Applicant: Japan Display Inc., Tokyo (JP)

(72) Inventors: Kaoru ITO, Tokyo (JP); Akihiko FUJISAWA, Tokyo (JP); Daichi ABE, Tokyo (JP); Norio MAMBA, Tokyo (JP)

(21) Appl. No.: 19/261,270

(22) Filed: Jul. 7, 2025

(30) Foreign Application Priority Data
Jul. 12, 2024 (JP) 2024-112421

(51) Int. Cl. G06V 20/70; G06T 7/62; G06T 7/73; G06T 11/00; G06V 10/147; G06V 10/25; H04N 23/56; H04N 23/63

(52) U.S. Cl. CPC G06V 20/70; G06T 7/62; G06T 7/73; G06T 11/001; G06V 10/147; G06V 10/25; H04N 23/56; H04N 23/63

(57) ABSTRACT

According to an aspect, a detection device includes: an optical sensor including photodetection elements; an object placement member having a light-transmitting property and configured such that objects to be detected are placed thereon; and a control circuit. The optical sensor is configured to acquire image data at intervals of a predetermined period. The control circuit is configured to: extract a first outline of at least one region from first image data, calculate first coordinates corresponding to the first outline, and label the first coordinates with first identification information; extract a second outline of at least one region from second image data, calculate second coordinates corresponding to the second outline not containing the first coordinates, and newly add second identification information corresponding to the second outline not containing the first coordinates; and calculate a total number of pieces of the first identification information and the second identification information.

### CROSS-REFERENCE TO RELATED APPLICATION

This application claims the benefit of priority from Japanese Patent Application No. 2024-112421 filed on Jul. 12, 2024, the entire contents of which are incorporated herein by reference.

### BACKGROUND

### 1. Technical Field

What is disclosed herein relates to a detection device.

### 2. Description of the Related Art

Japanese Patent Application Laid-open Publication No. 2018-033430 discloses an image acquisition device that includes an optical sensor, a container to contain microorganisms and a culture medium, and a light source, and acquires, over time, images indicating a growth of the microorganisms in the container.

In such detection devices, the accuracy of detection of an object to be detected is required to be improved.

### SUMMARY

According to an aspect, a detection device includes: an optical sensor including a plurality of photodetection elements arranged in a planar configuration; an object placement member having a light-transmitting property, placed so as to overlap the optical sensor, and configured such that a plurality of objects to be detected are placed thereon; and a control circuit configured to control the optical sensor. The optical sensor is configured to acquire image data at intervals of a predetermined period from start of measurement. The control circuit is configured to: perform predetermined processing on each of a plurality of pieces of the image data, extract a first outline of at least one region exceeding a predetermined threshold from first image data acquired in a first period, calculate first coordinates corresponding to the first outline, and label the first coordinates with first identification information corresponding to the first coordinates; extract a second outline of at least one region exceeding the predetermined threshold from second image data acquired in a second period after elapse of the predetermined period since the first period, calculate, when the at least one extracted second outline includes a second outline that does not contain the first coordinates, second coordinates corresponding to the second outline that does not contain the first coordinates, and newly add, to the second coordinates, second identification information corresponding to the second outline that does not contain the first coordinates; and calculate a total number of pieces of the first identification information used for labeling in the first image data and the second identification information newly used for labeling in the second image data.

### BRIEF DESCRIPTION OF THE DRAWINGS

FIG. 1 is a sectional view schematically illustrating a detection device according to an embodiment of the present disclosure;

FIG. 2 is a block diagram illustrating a configuration example of the detection device according to the embodiment;

FIG. 3 is a circuit diagram illustrating an optical sensor of the detection device according to the embodiment;

FIG. 4 is an explanatory diagram for explaining how the detection device according to the embodiment detects objects to be detected;

FIG. 5 is a block diagram illustrating a configuration example of a sensor control circuit according to the embodiment;

FIG. 6 is a flowchart for explaining how to extract an outline corresponding to an object to be detected, based on image data;

FIG. 7 is a flowchart for explaining various processes performed on the outline extracted in FIG. 6 and outputting of the image;

FIG. 8 is an explanatory diagram for explaining how to calculate differential image data;

FIG. 9 is an explanatory diagram for explaining how to extract the outline;

FIG. 10 is an explanatory diagram for explaining how to process coordinates and labeling for the outlines extracted from the image data;

FIG. 11 is a schematic diagram schematically illustrating an exemplary output image;

FIG. 12 is a schematic diagram schematically illustrating a configuration example of a detection system; and

FIG. 13 is a sectional view schematically illustrating an inspection unit included in the detection system.

### DETAILED DESCRIPTION

The following describes a mode (embodiment) for carrying out the present disclosure in detail with reference to the drawings. The present disclosure is not limited to the description of the embodiment given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate.

In the present disclosure, in expressing an aspect of disposing another structure on or above a certain structure, a case of simply expressing “on” includes both a case of disposing the other structure immediately on the certain structure so as to contact the certain structure and a case of disposing the other structure above the certain structure with still another structure interposed therebetween, unless otherwise specified.

### Embodiment

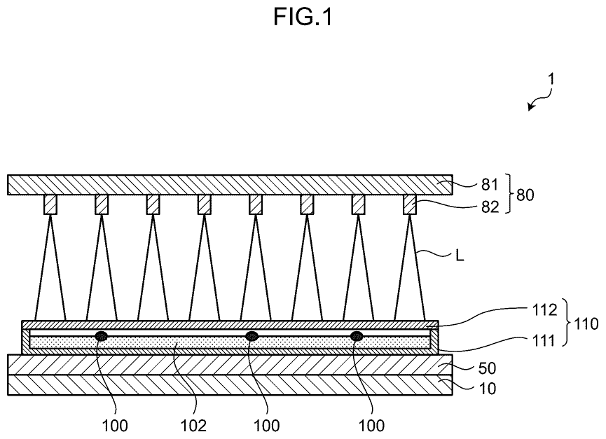

FIG. 1 is a sectional view schematically illustrating a detection device according to an embodiment of the present disclosure. As illustrated in FIG. 1, a detection device 1 includes an optical sensor 10, an optical filter layer 50, a container 110 for accommodating an object to be detected 100, and a light source 80. The container 110 (object to be detected 100) is disposed between the optical sensor 10 and the light source 80. In the present embodiment, the optical sensor 10, the optical filter layer 50, the container 110 (object to be detected 100), and the light source 80 are arranged in this order in the detection device 1. However, the order of arrangement is not limited to this order. The light source 80, the container 110 (object to be detected 100), the optical filter layer 50, and the optical sensor 10 may be arranged in this order in the detection device 1.

The object to be detected 100 is, for example, micro-objects such as bacteria. The bacteria or the like that have been cultured on a culture medium 102 (e.g., agar) and grown into a clump large enough to be visible may be referred to as a colony. The detection device 1 is a biosensor that detects the micro-objects such as the bacteria. The object to be detected 100 is not limited to the bacteria and may be other micro-objects such as cells.

The container 110 includes a container body 111 and a cover member 112. The container 110 is a Petri dish, for example. The container 110 is light-transmitting. The container body 111 contains the culture medium 102, and the object to be detected 100 is cultured on the culture medium 102. That is, the container 110 (at least the container body 111, of the container body 111 and the cover member 112) is an object placement member having a light-transmitting property and configured such that a plurality of the objects to be detected 100 are placed thereon.

In the present embodiment, the container 110 is placed such that the container body 111 is located on the lower side and the cover member 112 is located on the upper side. The container 110 is not limited to this placement, and may be placed upside down. That is, the container 110 may be placed such that the container body 111 is located on the upper side and the cover member 112 is located on the lower side. In this case, the objects to be detected 100 such as the bacteria are placed on the upper side of the culture medium 102 and cultured, and when imaging the objects to be detected 100, the container 110 is placed upside down to place the objects to be detected 100 on the lower side of the culture medium 102. The objects to be detected 100 serving as a detection target and the culture medium 102 are contained in the container 110 and placed between the optical sensor 10 and the light source 80.

The optical sensor 10 is a detection device including a plurality of photodiodes 30 arranged in a planar configuration. Each of the photodiodes 30 is a photodetection element that outputs an electrical signal corresponding to light emitted thereto. More specifically, the photodiode 30 is a positive-intrinsic-negative (PIN) photodiode using an inorganic semiconductor or an organic photodiode (OPD) using an organic semiconductor.

The optical filter layer 50 is a light directivity control element disposed between a plurality of light-emitting elements 82 (light source 80) and the photodiodes 30 (optical sensor 10). More specifically, the optical filter layer 50 is provided between the photodiodes 30 of the optical sensor 10 and the container 110. The optical filter layer 50 is disposed so as to face the photodiodes 30 of the optical sensor 10. The optical filter layer 50 is an optical element that transmits, toward the photodiodes 30, components of light emitted from the light-emitting elements 82 and traveling in a direction orthogonal to the optical sensor 10. The optical filter layer 50 is also called collimating apertures or a collimator. Alternatively, the optical filter layer 50 may be a louver or microlenses.

The light source 80 includes a light source board 81 and the light-emitting elements 82. The light-emitting elements 82 are point light sources provided correspondingly to the photodiodes 30 of the optical sensor 10. The light-emitting elements 82 are provided on the light source board 81 and arranged so as to face the photodiodes 30 of the optical sensor 10. Each of the light-emitting elements 82 is configured as a light-emitting diode (LED), for example.

The light emitted from the light-emitting elements 82 passes through the cover member 112, the culture medium 102, the container body 111, and the optical filter layer 50, and is emitted toward the photodiodes 30 of the optical sensor 10. The quantity of the light irradiating the photodiodes 30 differs between a region overlapping the objects to be detected 100 and a region not overlapping the objects to be detected 100. As a result, the optical sensor 10 can image the objects to be detected 100.

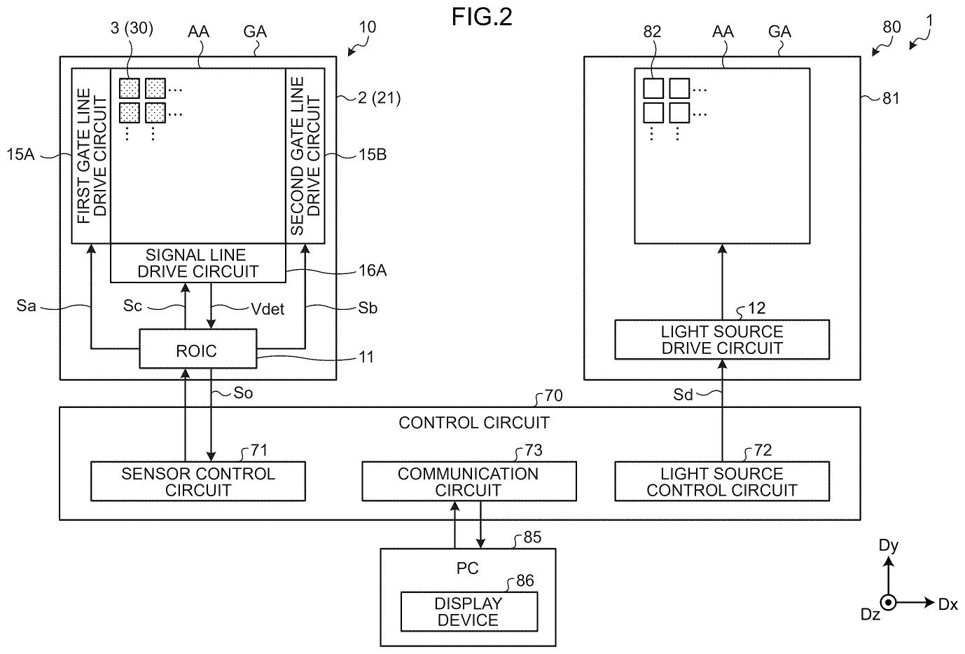

FIG. 2 is a block diagram illustrating a configuration example of the detection device according to the embodiment. As illustrated in FIG. 2, the detection device 1 further includes a control circuit 70 that controls the optical sensor 10 and the light source 80. The control circuit 70 synchronously (or non-synchronously) controls operations of detecting the objects to be detected 100 with the optical sensor 10 and operations of lighting the light-emitting elements 82 with the light source 80. The control circuit 70 includes, for example, a microcontroller unit (MCU), a random-access memory (RAM), an electrically erasable programmable read-only memory (EEPROM), and a read-only memory (ROM).

The optical sensor 10 includes an array substrate 2, a plurality of sensor pixels 3 (photodiodes 30) formed on the array substrate 2, a first gate line drive circuit 15A, a second gate line drive circuit 15B, a signal line drive circuit 16A, and a detection circuit 11.

The array substrate 2 is formed using a substrate 21 as a base. Each of the sensor pixels 3 is configured with the photodiode 30, a plurality of transistors, and various types of wiring. The array substrate 2 with the photodiodes 30 formed thereon is a drive circuit board for driving the sensor for each predetermined detection area and is also called a backplane or an active matrix substrate.

The substrate 21 has a detection area AA and a peripheral area GA. The sensor pixels 3 (photodiodes 30) are arranged in a matrix having a row-column configuration in the detection area AA. That is, the photodiodes 30 are arranged in a first direction Dx and a second direction Dy intersecting the first direction Dx. The first and second gate line drive circuits 15A and 15B, the signal line drive circuit 16A, and the detection circuit 11 are provided in the peripheral area GA.

In the following description, the first direction Dx is one direction in a plane parallel to the substrate 21. The second direction Dy is one direction in the plane parallel to the substrate 21 and is a direction orthogonal to the first direction Dx. The second direction Dy may, however, non-orthogonally intersect the first direction Dx. A third direction Dz is a direction orthogonal to the first direction Dx and the second direction Dy and is a direction normal to a principal surface of the substrate 21. The term “plan view” refers to a positional relation when viewed in a direction orthogonal to the substrate 21.

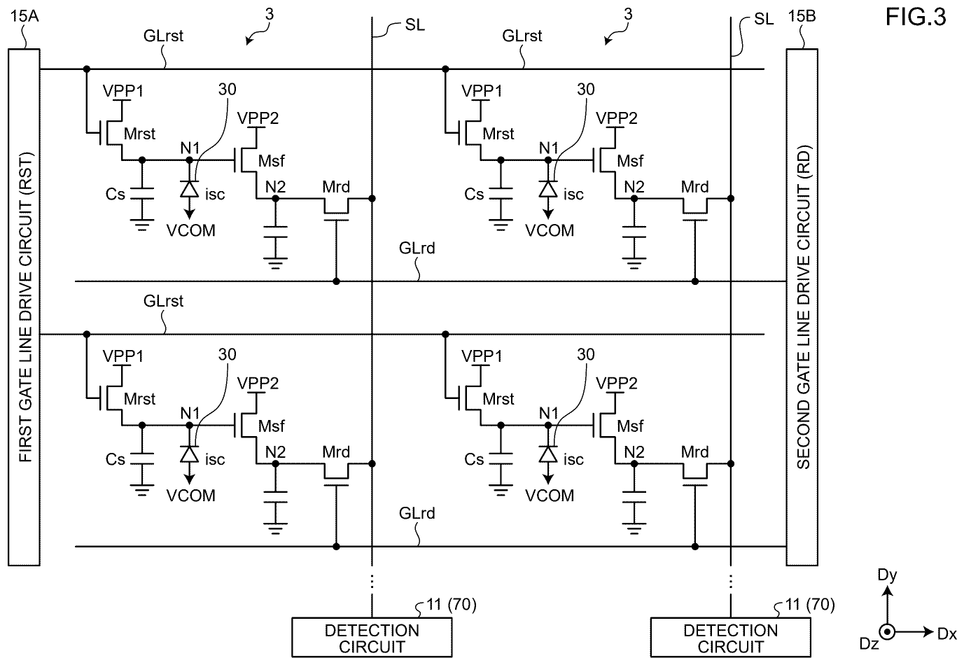

The detection circuit 11 is a circuit that supplies control signals Sa, Sb, and Sc to the first and second gate line drive circuits 15A and 15B, and the signal line drive circuit 16A, respectively, to control operations of these circuits. Specifically, the first gate line drive circuit 15A outputs a gate drive signal (for example, a reset control signal RST) to a reset control scan line GLrst (refer to FIG. 3) based on the control signal Sa. The second gate line drive circuit 15B outputs a gate drive signal (for example, a readout control signal RD) to a readout control scan line GLrd (refer to FIG. 3) based on the control signal Sb. The signal line drive circuit 16A electrically couples a signal line SL (refer to FIG. 3) selected based on the control signal Sc to the detection circuit 11.

The detection circuit 11 includes a signal processing circuit that processes a detection signal Vdet from each of the photodiodes 30. The detection circuit 11 includes a readout integrated circuit (ROIC). The detection circuit 11 may be provided in the peripheral area GA of the array substrate 2 or provided on a wiring board electrically coupled to the array substrate 2.

The photodiodes 30 included in the sensor pixels 3 perform detection in response to the gate drive signals supplied from the first and second gate line drive circuits 15A and 15B. Each of the photodiodes 30 outputs an electrical signal corresponding to the light emitted thereto as the detection signal Vdet to the signal line drive circuit 16A. The detection circuit 11 is electrically coupled to the photodiodes 30 via the signal line drive circuit 16A. The detection circuit 11 processes the detection signals Vdet from the photodiodes 30 and outputs sensor values So based on the detection signals Vdet to the control circuit 70. Thus, the detection device 1 detects information on the objects to be detected 100.

The light source 80 includes a light source drive circuit 12 that drives the light-emitting elements 82 mounted on the light source board 81. The light-emitting elements 82 are arranged in a matrix having a row-column configuration in a region of the light source board 81 overlapping the detection area AA. The light source drive circuit 12 supplies a power supply voltage (an anode power supply potential and a cathode power supply potential) to the light-emitting elements 82 based on a control signal Sd from the control circuit 70 (light source control circuit 72). This operation switches the light-emitting elements 82 between on (lit state) and off (unlit state).

The number and arrangement of the light-emitting elements 82 can be changed as appropriate. The light-emitting elements 82 may emit light in a single color or may be configured to emit light having multiple different wavelengths. The lighting pattern of the light-emitting elements 82 can also be changed as appropriate depending on the state of the objects to be detected 100 serving as the detection target. The light-emitting elements 82 may be simultaneously turned on or may be turned on in a time-division manner on a predetermined region basis.

The control circuit 70 includes a sensor control circuit 71 that controls the optical sensor 10, the light source control circuit 72 that controls the light source 80, and a communication circuit 73. The sensor control circuit 71 and the light source control circuit 72 control the optical sensor 10 and the light source 80, respectively, so that the detection operation of the optical sensor 10 and the lighting operation of the light source 80 are synchronously performed.

The communication circuit 73 couples the control circuit 70 to an external circuit 85 in a wired or wireless manner. The external circuit 85 is a personal computer (PC), for example. The external circuit 85 is not limited thereto and may be a portable device such as a tablet computer or a smartphone. Thus, information on the objects to be detected 100 detected by the detection device 1 is output to the external circuit 85 via the communication circuit 73. By operating the external circuit 85, a user enters various conditions, such as start and end timing of the detection of the detection device 1, and/or a threshold for determining the presence or absence of the objects to be detected 100.

The following describes a circuit configuration and an operation example of the optical sensor 10. FIG. 3 is a circuit diagram illustrating the optical sensor of the detection device according to the embodiment. As illustrated in FIG. 3, the sensor pixel 3 includes the photodiode 30, a reset transistor Mrst, a readout transistor Mrd, and a source follower transistor Msf. The sensor pixel 3 is provided with the reset control scan line GLrst and the readout control scan line GLrd as detection drive lines (gate lines) and provided with the signal line SL as wiring for signal reading.

The reset control scan line GLrst, the readout control scan line GLrd, and the signal line SL are each coupled to the sensor pixels 3. Specifically, the reset control scan line GLrst and the readout control scan line GLrd extend in the first direction Dx and are coupled to the sensor pixels 3 arranged in the first direction Dx. The signal line SL extends in the second direction Dy, and is coupled to the sensor pixels 3 arranged in the second direction Dy. The signal line SL is wiring through which signals from the transistors (readout transistor Mrd and source follower transistor Msf) are output.

The reset transistor Mrst, the readout transistor Mrd, and the source follower transistor Msf are provided correspondingly to one photodiode 30. The transistors included in the sensor pixel 3 are each configured as an n-type thin-film transistor (TFT). However, each of the transistors is not limited thereto, and may be configured as a p-type TFT.

A common voltage VCOM is applied to the anode of the photodiode 30. The cathode of the photodiode 30 is coupled to a node N1. The node N1 is coupled to the gate of the source follower transistor Msf and one of the source and the drain of the reset transistor Mrst. When the light irradiates the photodiode 30, a signal (electric charge) output from the photodiode 30 is stored in a capacitive element Cs formed at the node N1.

The gate of the reset transistor Mrst is coupled to the reset control scan line GLrst. The other of the source and the drain of the reset transistor Mrst is supplied with a reset voltage VPP1. When the reset transistor Mrst is turned on (conducting state) in response to the reset control signal RST supplied from the first gate line drive circuit 15A, the voltage of the node N1 is reset to the reset voltage VPP1. The common voltage VCOM has a voltage lower than the reset voltage VPP1, and the photodiode 30 is driven in a reverse bias state.

The source follower transistor Msf is coupled between a terminal supplied with a power supply potential VPP2 and the readout transistor Mrd (node N2). The gate of the source follower transistor Msf is coupled to the node N1. The gate of the source follower transistor Msf is supplied with a signal (voltage) corresponding to the signal (electric charge) generated by the photodiode 30. Thus, the source follower transistor Msf outputs a voltage corresponding to the signal (electric charge) generated by the photodiode 30 to the readout transistor Mrd.

The readout transistor Mrd is coupled between the source of the source follower transistor Msf (node N2) and the signal line SL. The gate of the readout transistor Mrd is coupled to the readout control scan line GLrd. When the readout transistor Mrd is turned on in response to the readout control signal RD supplied from the second gate line drive circuit 15B, the signal output from the source follower transistor Msf, that is, the signal (voltage) corresponding to the signal (electric charge) generated by the photodiode 30 is output as the detection signal Vdet to the signal line SL. The signal lines SL are each coupled to the detection circuit 11.

In FIG. 3, the reset transistor Mrst and the readout transistor Mrd each have a single-gate structure. However, the reset transistor Mrst and the readout transistor Mrd may each have what is called a double-gate structure composed of two transistors coupled in series or may be have a configuration composed of three or more transistors coupled in series. The circuit of one sensor pixel 3 is not limited to the configuration including the three transistors of the reset transistor Mrst, the source follower transistor Msf, and the readout transistor Mrd. The sensor pixel 3 may include two transistors or four or more transistors.

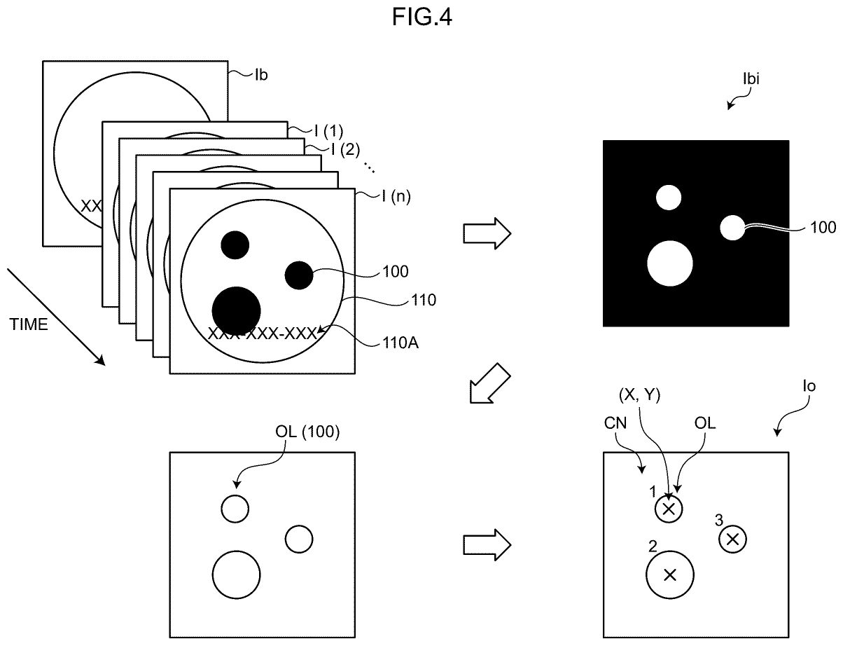

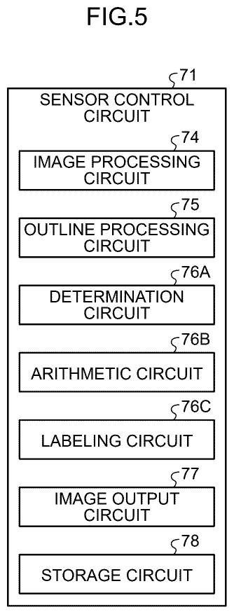

With reference to FIGS. 4 to 11, the following describes how the detection device 1 detects the objects to be detected 100. FIG. 4 is an explanatory diagram for explaining how the detection device according to the embodiment detects the objects to be detected. FIG. 5 is a block diagram illustrating a configuration example of the sensor control circuit according to the embodiment.

As illustrated in FIG. 4, the optical sensor 10 acquires a plurality of pieces of image data I(n) at intervals of a predetermined period. This operation allows the detection device 1 to acquire data on a change over time in growth of the objects to be detected 100 (colonies). The predetermined period for acquiring the multiple pieces of the image data I(n) is, for example, about 5 to 10 minutes, but is not limited to this period, and can be changed as appropriate depending on the type of the objects to be detected 100 (colonies), culturing conditions, and so forth.

As illustrated in FIG. 5, the sensor control circuit 71 includes an image processing circuit 74, an outline processing circuit 75, a determination circuit 76A, an arithmetic circuit 76B, a labeling circuit 76C, an image output circuit 77, and a storage circuit 78.

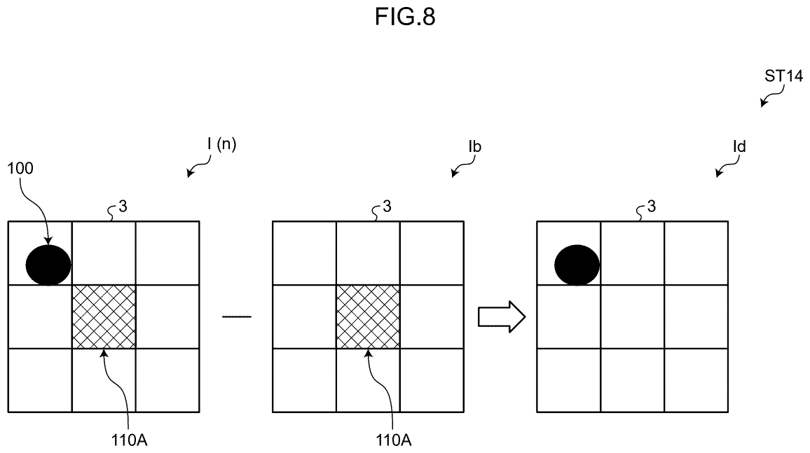

As illustrated in FIGS. 4 and 5, the image processing circuit 74 performs predetermined processing on each of the multiple pieces of the image data I(n) acquired by the optical sensor 10 at intervals of the predetermined period (where n is a natural number). Specifically, the image processing circuit 74 calculates the difference between the image data I(n) acquired during the predetermined period and initial image data Ib to generate differential image data Id (refer to FIG. 8). The image processing circuit 74 generates a binarized image Ibi based on a predetermined threshold set in advance and the differential image data Id.

The outline processing circuit 75 extracts an outline OL of a region exceeding the predetermined threshold (that is, a region corresponding to the object to be detected 100) based on the binarized image Ibi.

The determination circuit 76A compares the extracted outline OL with coordinates (X, Y) calculated corresponding to previous image data I(n−1) to determine whether the previous coordinates (X, Y) are included in a region surrounded by the outline OL.

The arithmetic circuit 76B calculates the coordinates (X, Y) corresponding to the extracted outline OL. The coordinates (X, Y) are, for example, center coordinates of the outline OL when approximated as a circle. However, the coordinates (X, Y) are not limited to them, and may be, for example, those of the geometric center of the area surrounded by the outline OL, or may be specified in other ways.

The labeling circuit 76C labels the calculated coordinates (X, Y) with identification information CN corresponding thereto. The labeling circuit 76C associates the extracted outline OL with the coordinates (X, Y) and the identification information CN corresponding to the coordinates (X, Y) and stores these associated items as a collective set of data in the storage circuit 78. The identification information CN is information such as numerics for distinguishing the multiple sets of the coordinates (X, Y) and the outlines OL corresponding thereto. However, the identification information CN is not limited to the numerics and may include information on other objects to be detected 100 as required.

The image output circuit 77 generates an output image Io by superimposing information such as the outline OL, the coordinates (X, Y), and the identification information CN on the image data I(n) acquired by the optical sensor 10. The image output circuit 77 outputs the generated output image Io to a display device 86 of the external circuit 85.

The storage circuit 78 stores therein the predetermined threshold, the multiple pieces of the image data I(n) acquired at intervals of the predetermined period, the differential image data Id, the binarized images Ibi, and various types of information including the outlines OL, the coordinates (X, Y), and the identification information CN, corresponding to the above items.

For ease of understanding of the explanation, FIG. 4 illustrates how to process one piece of the image data I(n) acquired during the predetermined period. However, in the present embodiment, the multiple pieces of the image data I(n) are acquired at intervals of the predetermined period and the growth of the objects to be detected 100 (colonies) is detected over time. Therefore, the shape of the outline OL may change over time, or a new object to be detected 100 (colony) may be detected at a certain time. Therefore, the detected object to be detected 100 may be difficult to be associated with the outline OL, the coordinates (X, Y), the identification information CN, and so forth. In addition, false detection may occur if foreign matter such as a printed text 110A or moisture is attached to the container 110.

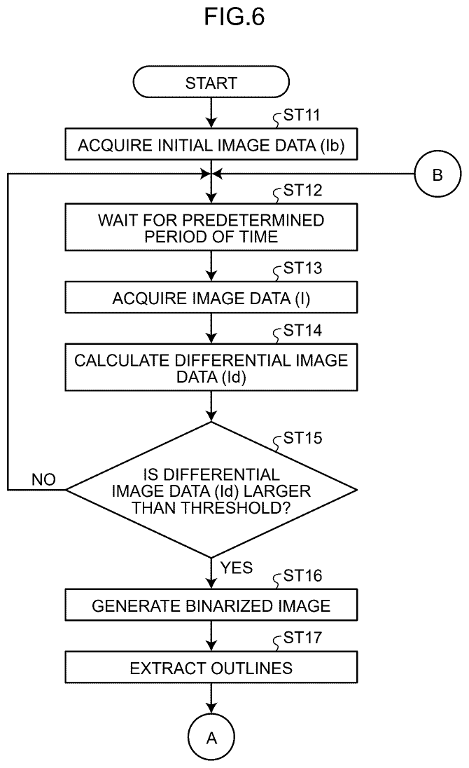

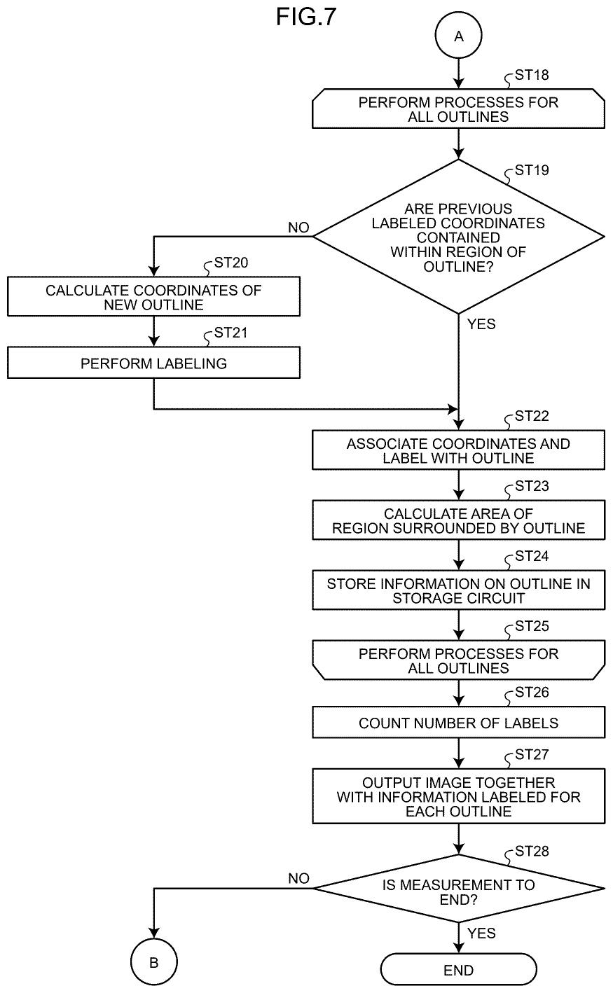

FIG. 6 is a flowchart for explaining how to extract the outline corresponding to the object to be detected, based on the image data. FIG. 7 is a flowchart for explaining various processes performed on the outline extracted in FIG. 6 and outputting of the image.

As illustrated in FIG. 6, the optical sensor 10 acquires the initial image data Ib (Step ST11). The initial image data Ib is image data based on the sensor values So obtained by scanning the photodiodes 30 of the optical sensor 10 in an initial state (for example, at time after power-on). The acquired initial image data Ib is stored in the storage circuit 78 of the sensor control circuit 71.

The optical sensor 10 waits for a predetermined period of time (Step ST12) after acquiring the initial image data Ib or after finishing processes from Step ST13 to Step ST28 to be described later. The predetermined period of time can be set or changed by operating the external circuit 85, and the information on the set predetermined period of time is stored in the storage circuit 78.

After the predetermined period of time has elapsed since the previous detection, the optical sensor 10 scans the photodiodes 30 to acquire the image data I(n) (Step ST13). The image data I(n) acquired at intervals of the predetermined period is stored in the storage circuit 78.

The acquired image data I(n), and the various types of differential image data Id, the binarized image Ibi, and the various types of information that are generated based on the image data I(n) are stored in the storage circuit 78 of the sensor control circuit 71 in a timely manner. In the following description, however, the storage process of the various types of image data and the various types of information in the storage circuit 78 will not be described.

The image processing circuit 74 calculates the difference between the initial image data Ib acquired at Step ST11 and the image data I(n) acquired at Step ST13 to generate the differential image data Id (Step ST14).

FIG. 8 is an explanatory diagram for explaining how to calculate the differential image data. As illustrated in FIG. 8, the image processing circuit 74 generates the differential image data Id by calculating the difference in the sensor value So between the image data I(n) and the initial image data Ib for each of the sensor pixels 3. As a result, even if the printed text 110A of the container 110, moisture, or dirt is attached to the container 110, for example, information such as the printed text 110A that does not change over time from the initial state is removed from the image data I(n), and the object to be detected 100 is well extracted. As a result, even if the foreign matter such as the printed text 110A is present, the influence of the printed text 110A and the like is eliminated in various processes at Step ST15 and subsequent steps, thereby accurately calculating the number, area (size), and the like of the objects to be detected 100.

Referring back to FIG. 6, the image processing circuit 74 compares the generated differential image data Id with the predetermined threshold (Step ST15). In more detail, the difference data of the sensor value So for each of the sensor pixels 3 of the differential image data Id is compared with the predetermined threshold. If the difference data is equal to or smaller than the predetermined threshold (No at Step ST15), the object to be detected 100 (colony) is determined to have not grown, and the process at Step ST12 is performed.

If the differential image data Id is larger than the predetermined threshold (Yes at Step ST15), the object to be detected 100 (colony) is determined to have grown, and the differential image data Id is processed.

The image processing circuit 74 generates the binarized image Ibi based on the differential image data Id (Step ST16). The image processing circuit 74 compares the differential image data Id with the predetermined threshold to binarize regions in which the differential image data Id is larger than the predetermined threshold (regions corresponding to the objects to be detected 100) and regions in which the differential image data Id is equal to or smaller than the predetermined threshold (region corresponding to a background). For example, in the example illustrated in FIG. 4, the binarized image Ibi is generated such that the regions corresponding to the objects to be detected 100 are displayed in white and the background is displayed in black.

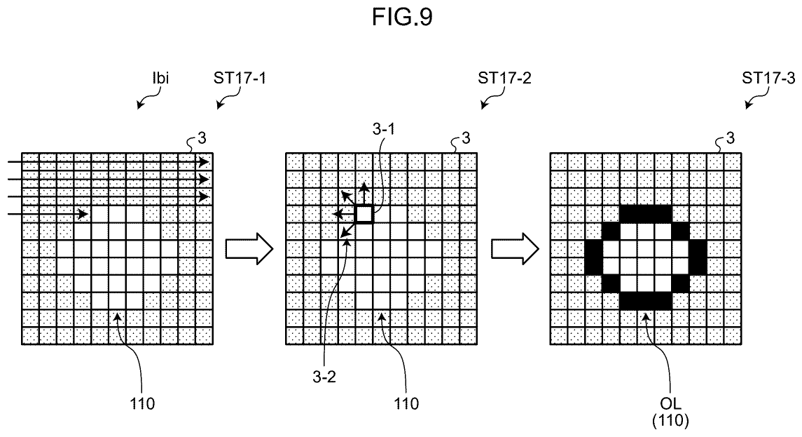

The outline processing circuit 75 extracts outlines of the regions in which the differential image data Id is larger than the predetermined threshold, based on the binarized image Ibi (Step ST17). FIG. 9 is an explanatory diagram for explaining how to extract the outline. As illustrated in FIG. 9, the outline processing circuit 75 performs raster scanning of the binarized image Ibi on a row basis for the sensor pixels 3 (Step ST17-1). As indicated by arrows at Step ST17-1 in FIG. 9, the outline processing circuit 75 performs the raster scanning, for example, from the first row of the sensor pixels 3. The outline processing circuit 75 detects a portion of the outline OL of the object to be detected 100 when the sensor pixel 3 corresponding to display in white (white pixel) is located next to the sensor pixel 3 corresponding to display in black (black pixel).

The outline processing circuit 75 checks the surrounding sensor pixels 3 counterclockwise starting from a sensor pixel 3-1 corresponding to a first detected portion of the outline OL (Step ST17-2). As indicated by arrows at Step ST17-2 in FIG. 9, the sensor pixels 3 around the sensor pixel 3-1 are checked counterclockwise, and when a sensor pixel 3 corresponding to the white display (for example, a sensor pixel 3-2) is located next to the sensor pixel 3 corresponding to the black display, the sensor pixel 3-2 is detected as the portion of the outline OL of the object to be detected 100. Then, another portion of the outline OL of the object to be detected 100 is detected around the sensor pixel 3-2 in the same way, and thus each portion of the outline OL is sequentially detected thereafter.

The outline processing circuit 75 repeats the process at Step ST17-2. When returning to the first sensor pixel 3-1, the outline processing circuit 75 connects all the detected portions of the outline OL, thereby extracting the outline OL of a region corresponding to the object to be detected 100 (Step ST17-3).

While FIG. 9 explains the extraction of one outline OL, if the binarized image Ibi includes the multiple objects to be detected 100, the outline processing circuit 75 performs the process in FIG. 9 a plurality of times to extract the outlines OL corresponding to the respective objects to be detected 100.

Then, as illustrated in FIG. 7, the sensor control circuit 71 performs processes from Step ST18 to Step ST25 for all the outlines OL.

The determination circuit 76A determines whether the coordinates (X, Y) labeled in the previous image data I(n−1) are contained within a region of one outline OL selected from the outlines OL extracted at Step ST17 (Step ST19).

If the coordinates (X, Y) labeled in the previous image data I(n−1) are not contained within the region of the selected outline OL (No at Step ST19), that is, if the outline OL is newly extracted in the image data I(n), the arithmetic circuit 76B calculates the coordinates (X, Y) of the new outline OL (Step ST20).

The labeling circuit 76C labels the coordinates (X, Y) corresponding to the newly extracted outline OL with the identification information CN (Step ST21).

The labeling circuit 76C associates the coordinates (X, Y) and the identification information CN (label) with the newly extracted outline OL in the image data I(n) (Step ST22).

The arithmetic circuit 76B calculates the area of the region surrounded by the newly extracted outline OL (Step ST23).

The storage circuit 78 stores therein the newly extracted outline OL in association with information, such as the coordinates (X, Y) and the identification information CN (label) (Step ST24).

If the region of the selected outline OL contains the coordinates (X, Y) labeled in the previous image data I(n−1) (Yes at Step ST19), the outline OL selected in the image data I(n) is associated with the coordinates (X, Y) calculated in the previous image data I(n−1) and the identification information CN used for labeling in the previous image data I(n−1) (Step ST22). The case where the determination of Yes is made at step ST19 is, in other words, a case where one of the outlines OL selected from among the outlines OL extracted in the image data I(n) corresponds to the outline OL already extracted in the previous image data I(n−1).

In other words, for the information on the outline OL, the coordinates (X, Y), and the identification information CN (label) that have been associated with one another in the previous image data I(n−1), the information on the outline OL acquired in the image data I(n) is updated and associated with the information on the coordinates (X, Y) and the identification information CN (label) while maintaining the information on the coordinates (X, Y) and the identification information CN (label).

Then, the arithmetic circuit 76B calculates the area of the region surrounded by the outline OL selected in the image data I(n) (Step ST23).

The storage circuit 78 associates the information, such as the coordinates (X, Y) and the identification information CN (label), with the outline OL extracted in the image data I(n), and stores them as one piece of data (Step ST24).

when the process at Step ST19 is performed for the first time, that is, when first image data I(1) is processed after the acquisition of the initial image data Ib, there is no identification information CN previously used for labeling, so that a transition to the process at Step ST20 is made.

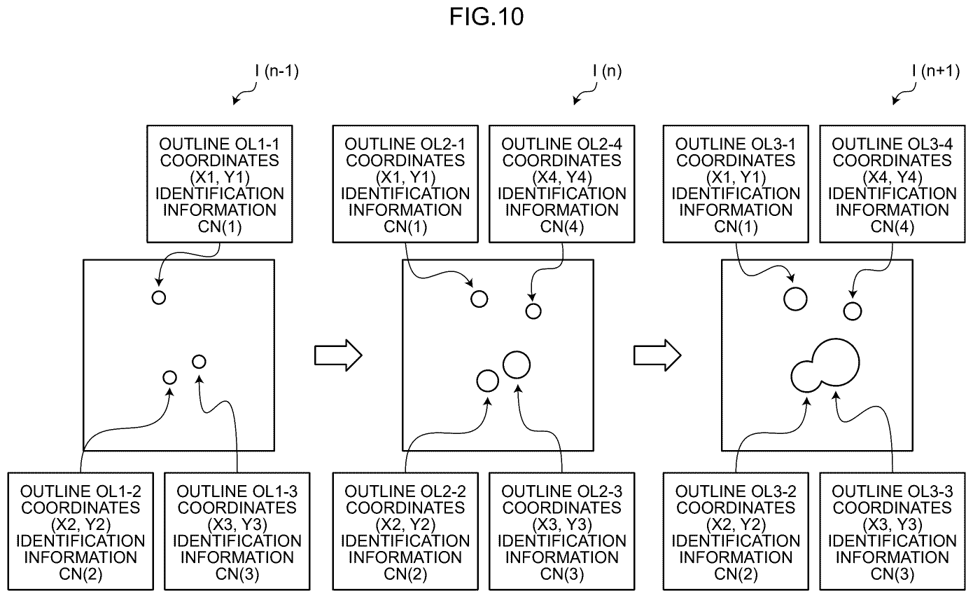

The following schematically describes a specific example of the processes from Step ST18 to Step ST25, with reference to FIG. 10. FIG. 10 is an explanatory diagram for explaining how to process the coordinates and the labeling for the outlines extracted from the image data. FIG. 10 explains processing of the image data I(n−1) acquired in an (n−1)th period, the image data I(n) acquired in an n-th period, and image data I(n+1) acquired in an (n+1)th period.

As illustrated in FIG. 10, three outlines OL1-1, OL1-2, and OL1-3 have been extracted up to the processing of the past image data I(n−1). Coordinates (X1, Y1) and identification information CN(1) are associated with the outline OL1-1 based on the image data I(n−1). In the same way, coordinates (X2, Y2) and identification information CN(2) are associated with the outline OL1-2, and coordinates (X3, Y3) and identification information CN(3) are associated with the outline OL1-3.

An outline OL2-4 is newly extracted in addition to three outlines OL2-1, OL2-2, and OL2-3 in the image data I(n). First, processing of the newly extracted outline OL2-4 among the four outlines OL will be described. The determination circuit 76A determines whether the coordinates (X1, Y1), (X2, Y2), and (X3, Y3) labeled in the previous image data I(n−1) are contained within a region of one outline OL2-4 selected from the four extracted outlines OL (corresponding to Step ST19).

Since the past coordinates (X1, Y1), (X2, Y2), and (X3, Y3) are not contained within the region of the outline OL2-4 (corresponding to No at Step ST19), the arithmetic circuit 76B calculates coordinates (X4, Y4) of the new outline OL2-4 (corresponding to Step ST20).

The labeling circuit 76C labels the coordinates (X4, Y4) corresponding to the newly extracted outline OL2-4 with identification information CN(4) (corresponding to Step ST21). Subsequently, the processes from Step ST22 to Step ST24 described above are performed on the newly extracted outline OL2-4.

The following describes processing on the outline OL (such as the outline OL2-1) among the four outlines OL that has been extracted up to the processing of the past image data I(n−1). The determination circuit 76A determines whether the coordinates (X1, Y1), (X2, Y2), and (X3, Y3) labeled in the previous image data I(n−1) are contained within a region of one outline OL2-1 selected from the four extracted outlines OL (corresponding to Step ST19).

Since the past coordinates (X1, Y1) are contained within the region of the outline OL2-1 (corresponding to Yes at Step ST19), the labeling circuit 76C associates the outline OL2-1 extracted in the image data I(n) with the coordinates (X1, Y1) and the identification information CN(1) calculated in the processing of the previous image data I(n−1) (corresponding to Step ST22).

In other words, for the information on the outline OL1-1, the coordinates (X1, Y1), and the identification information CN(1) that have been associated with one another in the processing of the previous image data I(n−1), the information on the previous outline OL1-1 is updated to the information on the outline OL2-1 newly acquired in the image data I(n) and then associated with the coordinates (X1, Y1) and the identification information CN(1) while maintaining the information on the coordinates (X1, Y1) and the identification information CN(1).

The arithmetic circuit 76B calculates the area of the region surrounded by the outline OL2-1 extracted in the image data I(n) (corresponding to Step ST23).

The storage circuit 78 stores therein the outline OL2-1 acquired in the image data I(n) so as to be associated with information such as the coordinates (X1, Y1) and the identification information CN(1) (corresponding to Step ST24).

The sensor control circuit 71 performs the same processing as that performed for the outline OL2-1 (or the outline OL2-4) described above for all the outlines OL acquired in the image data I(n). That is, information such as the coordinates (X2, Y2) and the identification information CN(2) is stored in the storage circuit 78 so as to be associated with the outline OL2-2. Information such as the coordinates (X3, Y3) and the identification information CN(3) is also stored in the storage circuit 78 so as to be associated with the outline OL2-3.

Similarly, in the processing of the image data I(n+1) acquired in the next (n+1)th period, information including the image coordinates (X1, Y1) and the identification information CN(1) inherited from the previous image data I(n) is stored in the storage circuit 78 so as to be associated with the outline OL3-1 extracted in the image data I(n+1). In the same way, information including the coordinates (X2, Y2) and the identification information CN(2) inherited from the previous image data I(n) is stored in the storage circuit 78 so as to be associated with the outline OL3-2 extracted in the image data I(n+1). Information including the coordinates (X3, Y3) and the identification information CN(3) inherited from the previous image data I(n) is stored in the storage circuit 78 so as to be associated with the outline OL3-3 extracted in the image data I(n+1). Information including the coordinates (X4, Y4) and the identification information CN(4) inherited from the previous image data I(n) is stored in the storage circuit 78 so as to be associated with the outline OL3-4 extracted in the image data I(n+1). In the (n+1)th period, the two adjacent outlines OL3-2 and OL3-3 are detected while being connected due to the growth of the objects to be detected 100 (colonies), but even in this case, the outlines OL3-2 and OL3-3 can be detected as the individual objects to be detected 100 (colonies), respectively, based on the previous coordinates (X, Y), the identification information CN, and so forth.

As described above, the coordinates (X, Y) calculated in the given image data I(n) and the identification information CN used for labeling correspondingly to the coordinates (X, Y) are inherited to the image data I(n+1) acquired in the subsequent period.

Referring back to FIG. 7, after performing the processes from Step ST19 to Step ST24 for all the outlines OL extracted in the image data I(n), the arithmetic circuit 76B counts the number of pieces of the identification information CN with which the coordinates (X, Y) is labeled (Step ST26). At Step ST26, the arithmetic circuit 76B counts the total number of pieces of the identification information CN used for labeling up to the processing of the past image data I(n−1) and inherited to the image data I(n), and the identification information CN newly used for labeling in the processing of the image data I(n).

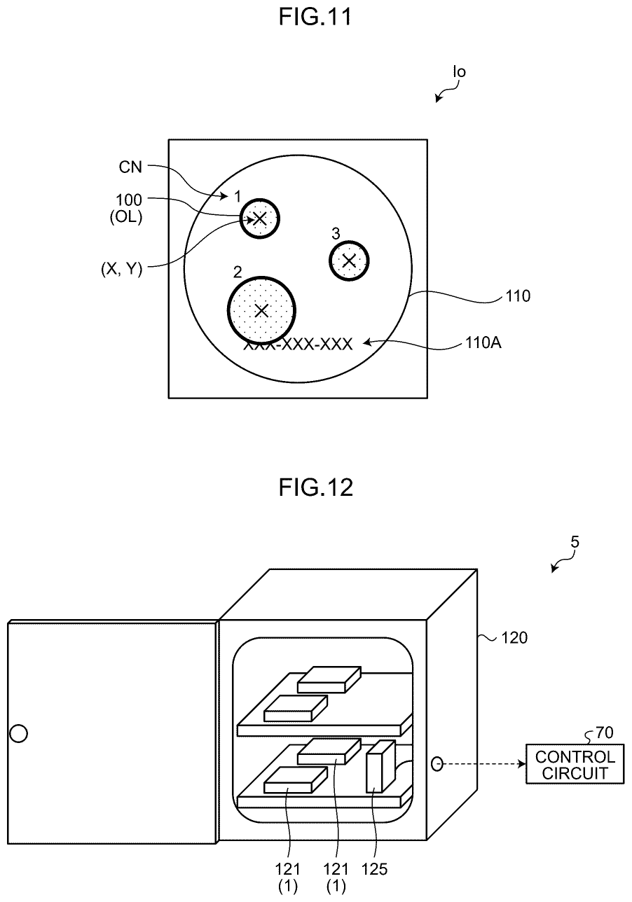

FIG. 11 is a schematic diagram schematically illustrating an example of the output image. The image output circuit 77 generates the output image Io by superimposing, on the image data I(n), the identification information CN used for labeling for each of the outlines OL and information including the coordinates (X, Y) corresponding to the outline OL, as illustrated in FIG. 11. The image output circuit 77 outputs the generated output image Io to the external circuit 85 (Step ST27). The output image Io is displayed on the display device 86 of the external circuit 85. The image output circuit 77 displays the outline OL in the output image Io with a line having a color or a color intensity different from that of the region surrounded by the outline OL.

The output image Io illustrated in FIG. 11 is merely an example, and the output image Io may be configured in any way. For example, information such as the identification information CN for labeling and the coordinates (X, Y) labeled therewith may be displayed in a region different from the output image Io.

The sensor control circuit 71 determines whether to end the measurement by the optical sensor 10 (Step ST28). The measurement by the optical sensor 10 is determined to end based on the number of measurements (or period of measurements) set in advance. Alternatively, the end of the measurement by the optical sensor 10 may be determined based on input from the external circuit 85. If ending the measurement (Yes at Step ST28), the sensor control circuit 71 stops driving the optical sensor 10. If continuing the measurement (No at Step ST28), the sensor control circuit 71 returns to the processing at Step ST12 to perform the measurement by the optical sensor 10 and process the image data I(n).

The procedure illustrated in FIGS. 6 to 7 is merely exemplary and can be changed as appropriate. For example, for the acquired image data I(n), a part of the processing on the detected objects to be detected 100 (extracted outlines OL) may be omitted, or other processing may be added as required.

As described above, the detection device 1 of the present embodiment extracts a first outline (such as the outlines OL1-1, OL1-2, and OL1-3) of at least one region exceeding the predetermined threshold from first image data (such as the image data I(n−1)) acquired in a first period (such as the (n−1)th period). The detection device 1 calculates first coordinates (such as the coordinates (X1, Y1), the coordinates (X2, Y2), and the coordinates (X3, Y3)) corresponding to the first outline, and labels the first coordinates with first identification information (such as the identification information CN(1), CN(2), and CN(3)) corresponding to the first coordinates. The detection device 1 extracts a second outline (such as the outlines OL2-1, OL2-2, OL2-3, and OL2-4) of at least one region exceeding the predetermined threshold from second image data (such as the image data I(n)) acquired in a second period (such as the n-th period) after the predetermined period of time has elapsed since the first period. The detection device 1 calculates, when the at least one extracted second outline includes a second outline (such as the outline OL2-4) that does not contain the first coordinates, second coordinates (such as the coordinates (X4, Y4)) corresponding to the second outline that does not contain the first coordinates. The detection device 1 newly adds, to the second coordinates, second identification information (such as the identification information CN(4)) corresponding to the second outline that does not contain the first coordinates. The sensor control circuit 71 calculates the total number of pieces of the first identification information (such as the identification information CN(1), CN(2), and CN(3)) used for labeling in the first image data and the second identification information (such as the identification information CN(4)) newly used for labeling in the second image data.

As a result, even if the shapes and areas (sizes) of the outlines OL have been changed by the growth of the objects to be detected 100 (colonies), the detection device 1 of the present embodiment can determine whether a detected object is the previously detected object to be detected 100 (outline OL) or the newly grown object to be detected 100 (outline OL). Even if the two adjacent outlines OL3-2 and OL3-3 are detected while being connected to each other due to the growth of the objects to be detected 100 (colonies) as illustrated in the image data I(n+1), the outline can be determined to be not the outline OL indicating one object to be detected 100 but two objects to be detected 100 (outlines OL), based on the previous coordinates (X, Y), the identification information CN, and so forth. That is, the detection device 1 can accurately detect the number of the object to be detected 100. As described above, the detection device 1 can improve the accuracy of detection of the objects to be detected 100 by processing the outlines OL and labeling the various types of information described above for each of the multiple pieces of the image data I(n) acquired at intervals of the predetermined period.

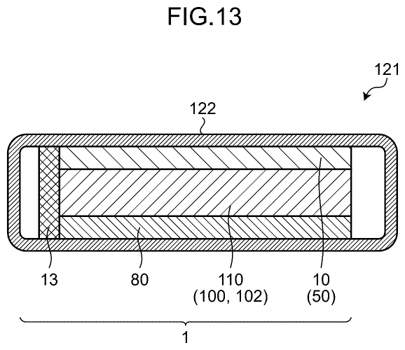

The following describes a detection system that includes the detection device 1 described above. FIG. 12 is a schematic diagram schematically illustrating a configuration example of the detection system. FIG. 13 is a sectional view schematically illustrating an inspection unit included in the detection system.

As illustrated in FIG. 12, a detection system 5 includes a plurality of detection units 121 (detection devices 1), the control circuit 70, and a coupling circuit 125 coupling the detection units 121 (detection devices 1) to the control circuit 70. The detection units 121 (detection devices 1) are electrically coupled to the common control circuit 70 via the coupling circuit 125.

As illustrated in FIG. 13, each of the detection units 121 includes the detection device 1 (optical sensor 10, optical filter layer 50, light source 80, and control board 13) and a housing 122. The detection device 1 (optical sensor 10, optical filter layer 50, light source 80, and control board 13) is placed in the housing 122. The container 110 containing the objects to be detected 100 and the culture medium 102 is placed between the optical sensor 10 (optical filter layer 50) and the light source 80. In the detection device 1, the light source 80, the container 110, and the optical sensor 10 (optical filter layer 50) are stacked in this order in the housing 122. However, the order of stacking in the detection device 1 is not limited to this order and may be a reversed order.

The detection circuit 11 (refer to FIG. 2) that processes the detection signal Vdet from the optical sensor 10 is mounted on the control board 13. The light source control circuit 72 (refer to FIG. 2) that controls the light source 80 may also be mounted on the control board 13.

An incubator 120 illustrated in FIG. 12 is maintained such that an environment (temperature, humidity, and the like) therein is suitable for culturing the objects to be detected 100 while a door is closed. The detection units 121 (detection devices 1) are placed in the incubator 120, and detects the objects to be detected 100 a plurality of times at preset timings (times). While not illustrated, the coupling circuit 125 is coupled to the detection units 121 (detection devices 1) via a wired or wireless manner. The detection units 121 (detection devices 1) each transmit the image data I(n) calculated by the detection circuit 11 to the control circuit 70 via the coupling circuit 125.

The detection system 5 includes the multiple detection units 121 (detection devices 1) and the control circuit 70, and therefore, can easily concurrently detect (image) the different objects to be detected 100. In the present embodiment, some of the processes performed by the sensor control circuit 71 illustrated in FIGS. 6 and 7 may be performed in a distributed manner among the detection units 121 (detection devices 1). In this case, the load of the arithmetic processing in the control circuit 70 can be reduced in the detection system 5 including the detection units 121 (detection devices 1).

While the preferred embodiment of the present disclosure has been described above, the present disclosure is not limited to the embodiment described above. The content disclosed in the embodiment is merely an example, and can be variously modified within the scope not departing from the gist of the present disclosure. Any modifications appropriately made within the scope not departing from the gist of the present disclosure also naturally belong to the technical scope of the present disclosure. At least one of various omissions, substitutions, and changes of the components can be made without departing from the gist of the embodiment described above.

What is claimed is:

1. A detection device comprising:
an optical sensor comprising a plurality of photodetection elements arranged in a planar configuration;
an object placement member having a light-transmitting property, placed so as to overlap the optical sensor, and configured such that a plurality of objects to be detected are placed thereon; and
a control circuit configured to control the optical sensor, wherein
the optical sensor is configured to acquire image data at intervals of a predetermined period from start of measurement,
the control circuit is configured to:
perform predetermined processing on each of a plurality of pieces of the image data;
extract a first outline of at least one region exceeding a predetermined threshold from first image data acquired in a first period, calculate first coordinates corresponding to the first outline, and label the first coordinates with first identification information corresponding to the first coordinates;
extract a second outline of at least one region exceeding the predetermined threshold from second image data acquired in a second period after elapse of the predetermined period since the first period, calculate, when the at least one extracted second outline includes a second outline that does not contain the first coordinates, second coordinates corresponding to the second outline that does not contain the first coordinates, and newly add, to the second coordinates, second identification information corresponding to the second outline that does not contain the first coordinates; and
calculate a total number of pieces of the first identification information used for labeling in the first image data and the second identification information newly used for labeling in the second image data.

2. The detection device according to claim 1, wherein, when the at least one second outline extracted in the second image data includes a second outline containing the first coordinates corresponding to the first outline extracted in the first image data, the first coordinates and the first identification information corresponding to the first coordinates are associated with the second outline that contains the first coordinates.

3. The detection device according to claim 1, wherein the control circuit is configured to generate an output image by superimposing, on the second image data, the extracted second outline and the second coordinates or the first coordinates corresponding to the second outline, and cause a display device to display the output image.

4. The detection device according to claim 3, wherein the second outline is displayed in the output image with a line having a color or a color intensity different from that of a region surrounded by the second outline.

5. The detection device according to claim 1, wherein the control circuit is configured to calculate an area of a region surrounded by the second outline.

6. The detection device according to claim 1, comprising a light directivity control element disposed between the photodetection elements and the object placement member.

7. The detection device according to claim 6, wherein the light directivity control element is a louver, a collimator, or microlenses.

8. The detection device according to claim 1, comprising a light source configured to emit light to the photodetection elements.
